(19) United States
(12) Patent Application Publication
(10) Pub. No.: US 2003/0235699 A1
(43) Pub. Date: Dec. 25, 2003

(54) Plated component for use in an outdoor environment

(75) Inventors: Yasushi Nishimura, Izumi-shi (JP); Yuzuru Uchiyama, Kaizuka-shi (JP)

Correspondence Address: James A. Deland, DELAND LAW OFFICE, P.O. Box 69, Klamath River, CA, 96050-0069, US

(73) Assignee: Shimano, Inc.

(21) Appl. No.: 10/434,575

(22) Filed: May 8, 2003

(30) Foreign Application Priority Data
May 9, 2002 (JP) 2002-134412

(51) Int. Cl. B32B 15/04

(52) U.S. Cl. 428/469; 428/472

(57) ABSTRACT

A plated component used in an outdoor environment comprises a component main unit, a metal coating formed over at least a part of the component main unit, and an oxide coating formed over at least a part of the component main unit.

### BACKGROUND OF THE INVENTION

The present invention is directed to a plated component and, more particularly, to a plated component used in an outdoor environment.

In order to achieve light weight and a high-quality appearance, fishing components, bicycle components, and other components that are intended to be used in an outdoor environment often are made from an aluminum alloy, a magnesium alloy or a synthetic resin with resin plating. In a component made of aluminum alloy, the component usually is molded using a die-cast forming or squeeze-cast forming. These types of forming processes allow complex shapes to be formed at low cost. Where such forming processes are used, a large quantity of silicone is added to the aluminum alloy in order to increase the flowability of the molten aluminum. An Alumite coating is often formed over the surface of the aluminum alloy component in order to increase the corrosion resistance of the component and to improve its appearance. In a component made of a magnesium alloy, an anodic oxide coating often is formed on the surface of the component in order to improve corrosion resistance, and a corrosion-resistant coating is further formed on the surface by painting or by some other method. In a component made of synthetic resin, a coating often is formed on the surface of the component using a physical deposition method such as ion plating or sputtering.

When aluminum alloy is used to form the component and a large amount of silicone is added to the aluminum, flow marks become conspicuous or the color becomes gray. These features tend to dull the surface color. Even if cutting is carried out in order to prevent such effects, it is difficult to control the cutting process. As a result of such cutting, flow marks are still apparent after an Alumite coating is applied, and the luster of the surface changes at the border between chilled layers and non-chilled layers. Consequently, even where an Alumite coating is used, a high-quality external appearance with a metallic luster is difficult to obtain in a variety of colors.

When a magnesium alloy is used to form the component, any anodic oxide coating becomes white, green or brown depending on the anodic oxidation process used. As a result, it is difficult to obtain a metallic appearance for the alloy material, and high-quality external appearance with a metallic luster is difficult to obtain in a variety of colors. One possible countermeasure that attempts to prevent this phenomenon is to form a chrome coating on top of the anodic oxide coating via physical deposition and then apply decorative paint over the chrome coating. While a metallic luster can be obtained from the chrome coating, the desired hardness is not achieved because of the painted surface, and the surface is susceptible to damage.

When a synthetic resin is used to form the component, because metal plating is formed on the surface of the resin component, the surface color is limited to the color of the plated metal. Here as well, it is difficult to obtain a high-quality, lustrous metal appearance in a variety of colors.

### SUMMARY OF THE INVENTION

The present invention is directed to various features of a plated component. In one embodiment, a plated component used in an outdoor environment comprises a component main unit, a metal coating formed over at least a part of the component main unit, and an oxide coating formed over at least a part of the component main unit. Additional inventive features will become apparent from the description below, and such features alone or in combination with the above features may form the basis of further inventions as recited in the claims and their equivalents.

### BRIEF DESCRIPTION OF THE DRAWINGS

FIG. 1 is a side view of a particular embodiment of a bicycle that includes a particular embodiment of a plated component;

FIG. 2 is a front view of a particular embodiment of a right gear crank of the bicycle shown in FIG. 1;

FIG. 3 is a cross-sectional view of a portion of a crank having a plated component;

FIGS. 4(A)-4(C) are cross-sectional views illustrating a particular embodiment of a manufacturing process for a plated component;

FIG. 5 is a side view of a particular embodiment of a spinning reel assembly that includes a particular embodiment of a plated component; and

FIG. 6 is a cross-sectional view of a portion of the spinning reel assembly having a plated component.

### DETAILED DESCRIPTION OF THE EMBODIMENTS

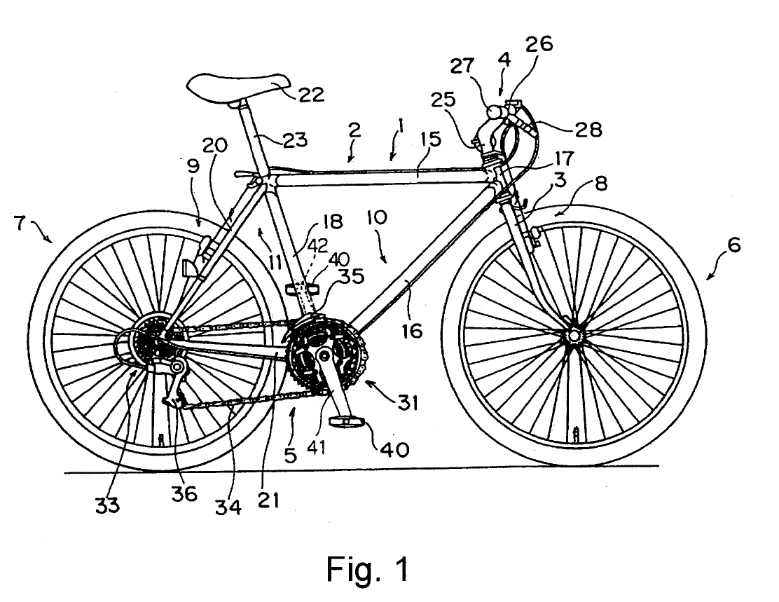

FIG. 1 is a side view of a particular embodiment of a bicycle that includes a particular embodiment of a plated component. In this embodiment, the bicycle is an MTB type of bicycle that includes a diamond-shaped frame 1 comprising a frame body 2 formed from aluminum tubes connected via Tig welding, for example, and a front fork 3 that is rotatably mounted to the front of the frame body 2. Fork 3 is mounted to frame body 2 such that it can rotate around an axis that is essentially vertical but angled somewhat relative to the bicycle body, and it is divided into two arms at the bottom part thereof. The MTB further includes a handlebar unit 4 that is linked to the front fork 3, a drive unit 5 that is mounted to the lower part of the frame body 2 and converts pedaling by the rider into drive power, a front wheel 6 that is rotatably supported by the bottom ends of the front fork 3, a rear wheel 7 that is rotatably supported by the rear part of the frame body 2, and front and rear brake devices 8 and 9.

The frame body 2 has a front triangle 10 and a rear triangle 11 that is disposed behind the front triangle 10. The front triangle 10 comprises a top tube 15 that is disposed horizontally, a down tube 16 that is disposed under the top tube 15 such that it rises toward the front, a head tube 17 that connects the front ends of the top tube 15 and the down tube 16, and a seat tube 18 that extends diagonally upward and to which the rear ends of the top tube 15 and the down tube 16 are connected. A seat post 23 to which a saddle 22 is secured is mounted to the seat tube 18 such that it can be adjusted upward and downward. A bottom bracket unit (not shown) is formed at the intersection of the seat tube 18 and the down tube 16. The rear triangle 11 comprises a pair of seatstays 20 that are connected at the front ends thereof to the seat tube 18, and a pair of chain stays 21 that extend to the back of the bicycle and are connected to the rear ends of the seatstays 20.

Handlebar unit 4 includes a handlebar stem 25 that is secured to the top of the front fork 3 such that it can be adjusted upward and downward. A handlebar 26 is secured to the top end of the handlebar stem 25 and extends in the right and left directions. A grip 27 is placed over the outer circumference of each end of the handlebar 26, and a brake lever 28 that includes a speed-changing lever is mounted to the inside of either grip 27.

The drive unit 5 has a gear crank unit 31 rotatably mounted to the bottom bracket unit, a rear gear cluster 33 non-rotatably mounted to a free hub of the rear wheel 7, and a chain 34 that engages the gear crank unit 31 and the rear gear cluster 33. The gear crank unit 31 has a right gear crank 41 and a left gear crank (not shown), and a pedal 40 is mounted to the distal end of each gear crank. A crankshaft (not shown) extends through the bottom bracket unit and links the right gear crank 41 and the left gear crank. A front derailleur 35 moves the chain 34 among the gears that form a part of gear crank unit 31, and a rear derailleur 36 moves the chain 34 among the plurality gears that form the rear gear cluster 33.

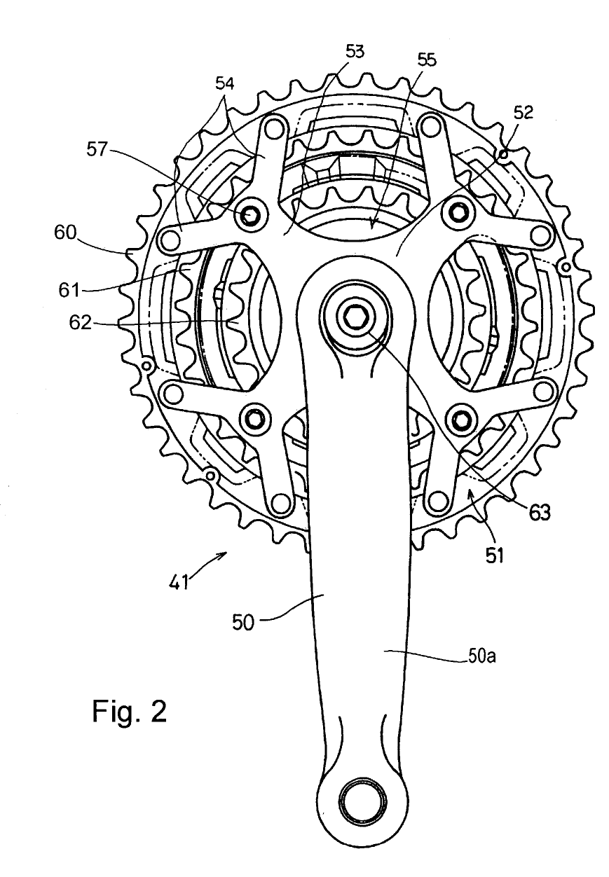

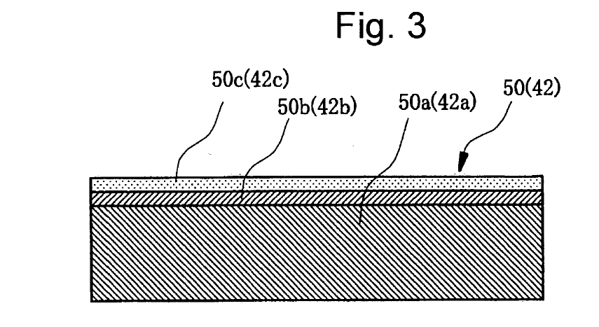

As shown in FIGS. 2 and 3, the right gear crank 41 has a bar-shaped crank 50. A pedal 40 is mounted to one end of crank 50 (FIG. 1), and a gear plate 51 is non-rotatably mounted to the other end of crank 50. The crank 50 and the gear plate 51 are secured to the crankshaft in a known manner through a mounting bolt 63.

The gear plate 51 has a crank mounting member 52 with internal splines (not shown) so that crank mounting member 52 can nonrotatably engage corresponding outer splines (not shown) on crank 50. A crank arm member 55 has four arms 53 that extend radially outwardly in four directions from the crank mounting member 52. Each arm 53 has an associated pair of gear securing areas 54, each of which extend outwardly in two opposite directions at the tip of each arm 53. Mounting screw holes 57 are formed in the crank arm member 55 such that there is one such hole in each arm 53. A ring-shaped outer gear 60 is riveted to the gear securing areas 54 in eight locations, and a center gear 61 having fewer teeth than the outer gear 60 is mounted to the mounting screw holes 57 coaxially with the outer gear 60. Additionally, a mounting screw hole (not shown) used for mounting an inner gear 62 is formed on the rear surface of each arm 53.

The crank 50 is made from an aluminum alloy and has a component main unit 50a, an aluminum coating 50b (FIG. 3) that is formed on at least the surface of the main unit 50a that is exposed to the outdoor environment, and an Alumite coating 50c that is formed on top of the aluminum coating. The left crank 42 has essentially the same construction as the right crank 50, except for the gear plate 51. Accordingly, left crank 42 has a component main unit 42a, an aluminum coating 42b and an Alumite coating 42c.

In this embodiment, the component main unit 50a comprises a hollowed-out die-cast aluminum alloy. The aluminum alloy used for the component main unit 50a contains between 0.3 percent and 18 percent of silicone by weight. When the aluminum alloy contains this percentage of silicone, the molten aluminum alloy flows more easily and can be formed into highly precise configurations.

In this embodiment, the aluminum coating 50b comprises and aluminum alloy having a thickness in a range from approximately 2 μm to approximately 20 μm, for example. When the aluminum coating 50b is thicker than this range, it peels off easily, and when it is thinner, the Alumite coating 50c becomes thin and peels off easily. Coating 50b is formed using a conventional physical deposition method such as sputtering, vacuum deposition, ion plating, etc.

In this embodiment, the Alumite coating 50c is formed via anodic oxidation on top of the aluminum coating 50b that was formed via physical deposition. The Alumite coating 50c then undergoes a conventional sealing process such as vapor sealing, and it may be lightly stained with a color such as blue, for example.

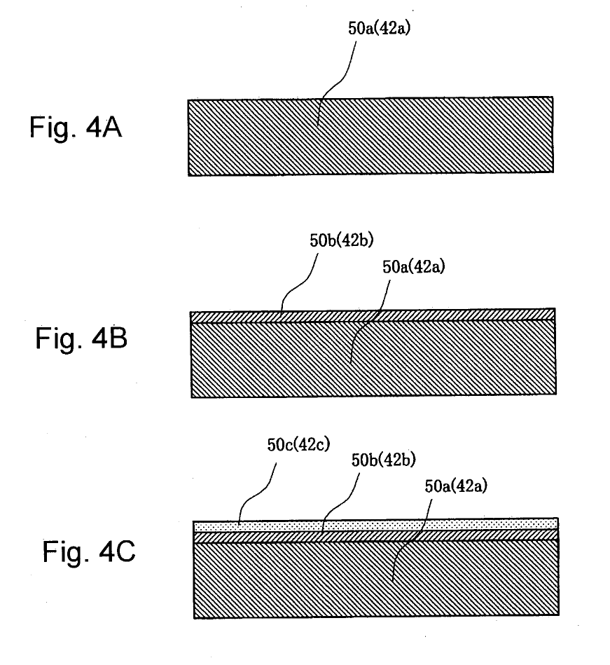

The manufacturing process for the right crank 50 will now be described with reference to FIGS. 4(A)-4(C). Because the manufacturing process for the left crank 42 is identical to the process for the right crank 50, description thereof will be omitted.

First, an aluminum alloy material formed in the shape of the component main unit 50a of the right crank 50 is prepared using die-cast forming, as shown in FIG. 4(A). Then, an aluminum coating 50b (e.g., pure aluminum, an aluminum alloy, etc) is formed on the exposed surface of the component main unit 50a as shown in FIG. 4(B) using a conventional physical deposition method. In this embodiment, an ion plating method is preferred for the formation of the aluminum coating 50b in order to increase adhesiveness, but the sputtering method or the vacuum deposition method may be used as well. An Alumite coating 50c is then formed on top of the aluminum coating 50b as shown in FIG. 4(C) using a conventional anodic oxidation method. If desired, the Alumite coating 50c may be colored a unique color via staining or electrolytic coloring. Finally, the Alumite coating 50c can be completely sealed, partially sealed or not sealed. Complete sealing improves corrosion resistance, while the absence of sealing improves adhesiveness. As a result, whether or not sealing is to be performed may be determined in accordance with the environment in which the component is to be used. Coloring may be carried out simultaneously with sealing.

In this embodiment, because the Alumite coating 50c is formed on top of the smooth surface of the aluminum coating 50b formed via physical deposition, the appearance of the exterior of the material comprising the component main unit 50a is shielded from view by the aluminum coating 50b and Alumite coating 50c. Thus, a high-quality, lustrous metal appearance can be obtained in a variety of colors without being affected by such material. Furthermore, because the Alumite coating 50c is formed in the manner of a ceramic, the component becomes harder and more damage-resistant.

In the previous embodiment, a plated component was described using a bicycle component as an example, but the described process also may be used for other components, such as a main unit of a fishing reel.

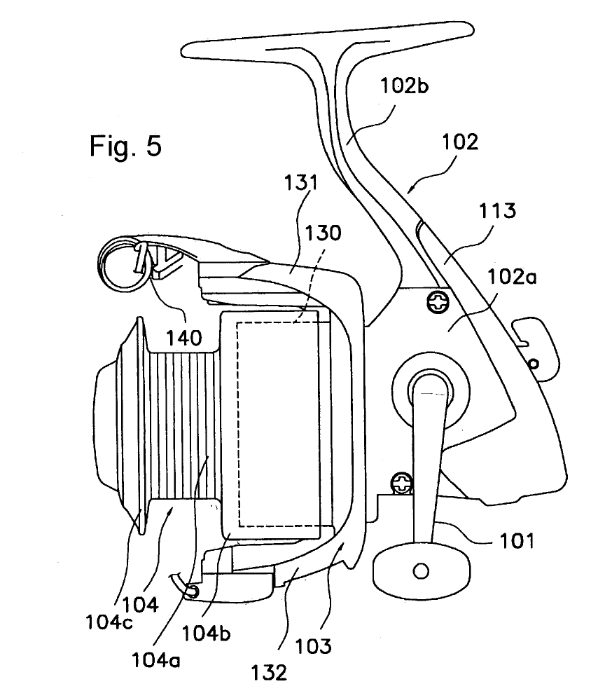

FIG. 5 is a side view of a particular embodiment of a spinning reel assembly that includes a particular embodiment of a plated component. The spinning reel assembly includes a handle assembly 101, a reel main unit 102 to which the handle assembly 101 is mounted such that handle assembly 101 can rotate around an axis that extends from the right to left of the reel (upwardly from the page in FIG. 5), a rotor 103, and a spool 104. The rotor 103 rotates in tandem with the rotation of the handle assembly 101 and guides the fishing line to the spool 104. Rotor 103 is rotatably supported at the front of the reel main unit 102 such that it can rotate around an axis that extends from the front to the back of the reel (to the left and right in FIG. 5). The spool 104 winds the fishing line guided by the rotor 103 around its outer circumference, and it is disposed at the front of the rotor 103 such that it can move back and forth, i.e., forward and backward, along its axis.

The reel main unit 102 has a hollow reel body 102a made from a magnesium alloy, for example, and a T-shaped rod mounting leg 102b that is also made from a magnesium alloy and that extends from the reel body 102a diagonally upward and toward the front as a single unit. Disposed inside the reel body 102a are a rotor drive mechanism (not shown) and an oscillating mechanism (not shown). The rotor drive mechanism causes the rotor 103 to rotate in tandem with the rotation of the handle assembly 101, and the oscillating mechanism moves the spool 104 forward and backward to ensure that the fishing line is taken up evenly on the spool. A protective cover 113 made of metal or synthetic resin, for example, covers the rear of the reel main unit 102. The protective cover 113 is disposed such that it extends from the bottom of reel main body 102, along the back of the reel body 102a to the rod mounting leg 102b, thereby covering the bottom and the back of the reel main unit 102. The protective cover 113 is removably secured to the reel main unit 102 using screws.

The rotor 103 has a cylindrical member 130 that is rotatably mounted to the reel main unit 102, first and second rotor arms 131 and 132 that extend forwardly from the outer circumferential surface of the back part of the cylindrical member 130 in a manner that forms a gap between rotor arms 131 and 132 and the cylindrical member 130, and a bail arm 140 that is movably mounted to both rotor arms and operates to guide the fishing line.

The spool 104 has a grooved construction, and it is disposed between the first rotor arm 131 and the second rotor arm 132. The spool 104 is linked to the distal end of a spool shaft (not shown) via a drag mechanism (not shown) that creates a drag force on the spool 104. The spool 104 has a line winding barrel 104a, a skirt 104b that is integrally formed with the back part of the line winding barrel 104a, and a front flange 104c that is disposed at the front end of the line winding barrel 104a. Line winding barrel 104a is made of lightweight aluminum alloy, for example, and it is used for winding a fishing line. The skirt 104b is a bottomed cylindrical member that first extends radially from the back end of the line winding barrel 104a and then extends straight backward such that it covers the cylindrical member 130 of the rotor 103.

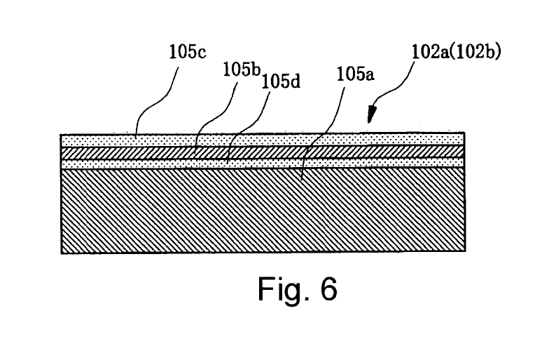

The reel body 102a and rod mounting leg 102b include, as shown in FIG. 6, a component main unit 105a made from magnesium alloy, a magnesium oxide coating (anodic oxide coating) 105d formed on the exposed surface of the component main unit 105a, an aluminum coating 105b formed on top of the magnesium oxide coating 105d, and an Alumite coating 105c formed on top of the aluminum coating 105b. The aluminum coating 105b and the Alumite coating 105c are identical to the corresponding coatings described in connection with the first embodiment. One difference between this embodiment and the first embodiment is that an anodic oxide coating 105d is formed on the surface of the component main unit 105a. Because magnesium alloy corrodes more easily that aluminum alloy, the magnesium oxide coating 105d is formed on top of the component main unit 105a in order to improve corrosion resistance.

Because the component main unit 105a is made from magnesium alloy, it can be made very lightweight. Also, since an anodic oxide coating 105d is formed on the surface of the magnesium alloy, the adhesiveness of the aluminum coating 105b is increased and corrosion resistance is improved. Because the reel main unit 102 of the spinning reel has an Alumite coating 105c formed via physical deposition on top of the smooth surface of the aluminum coating 105b, the appearance of the exterior of the material comprising the component main unit 105a is shielded from view by the aluminum coating 105b and Alumite coating 105c. Thus, a high-quality, lustrous metal appearance can be obtained in a variety of colors without being affected by the component main unit 105a. Also, because the Alumite coating 105c is formed ceramic-like, the component main unit 105a becomes harder and more damage-resistant.

While the above is a description of various embodiments of inventive features, further modifications may be employed without departing from the spirit and scope of the present invention. For example, different metals and oxide coatings as well as synthetic resins may be used in place of the materails specifically described. In the case of a component main unit made of synthetic resin, it is acceptable if an aluminum coating is formed on the synthetic resin component main unit and an Alumite coating is formed on top of the aluminum coating.

In the above embodiments, a bicycle crank or the main unit of a spinning reel was described as an example of the component exposed to an outdoor environment, but the present invention is not limited to these examples. The teachings herein may be applied to a different component, such as a gear shift mechanism, a brake lever, a wheel hub or rim of a bicycle, a spool or rotor of a fishing reel, and so on.

The size, shape, location or orientation of the various components may be changed as desired. Components that are shown directly connected or contacting each other may have intermediate structures disposed between them. The functions of one element may be performed by two, and vice versa. The structures and functions of one embodiment may be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the scope of the invention should not be limited by the specific structures disclosed or the apparent initial focus or emphasis on a particular structure or feature.

What is claimed is:

1. A plated component used in an outdoor environment comprising:
a component main unit;
a metal coating formed over at least a part of the component main unit; and
a first oxide coating formed over at least a part of the component main unit.

2. The component according to claim 1 wherein the component main unit comprises aluminum.

3. The component according to claim 2 wherein the component main unit is formed via die forming.

4. The component according to claim 2 wherein the component main unit comprises an aluminum alloy.

5. The component according to claim 4 wherein the component main unit contains from approximately 0.3% to approximately 18% by weight of silicone.

6. The component according to claim 2 wherein the metal coating comprises an aluminum coating.

7. The component according to claim 2 wherein the first oxide coating comprises an anodic oxide coating.

8. The component according to claim 7 wherein the metal coating comprises an aluminum coating.

9. The component according to claim 2 wherein the first oxide coating is formed over the metal coating.

10. The component according to claim 9 wherein the metal coating is formed on at least a portion of a surface of the component main unit.

11. The component according to claim 9 wherein the first oxide coating is formed on at least a portion of a surface of the metal coating.

12. The component according to claim 9 wherein the metal coating is formed on at least a portion of a surface of the component main unit, and wherein the first oxide coating is formed on at least a portion of a surface of the metal coating.

13. The component according to claim 12 wherein the component main unit comprises an aluminum alloy.

14. The component according to claim 13 wherein the component main unit contains from approximately 0.3% to approximately 18% by weight of silicone.

15. The component according to claim 12 wherein the first oxide coating comprises an anodic oxide coating.

16. The component according to claim 12 wherein the metal coating comprises an aluminum coating.

17. The component according to claim 16 wherein the first oxide coating comprises an anodic oxide coating.

18. The component according to claim 1 wherein the component main unit comprises a synthetic resin.

19. The component according to claim 18 wherein the metal coating comprises an aluminum coating.

20. The component according to claim 18 wherein the first oxide coating comprises an anodic oxide coating.

21. The component according to claim 20 wherein the metal coating comprises an aluminum coating.

22. The component according to claim 18 wherein the first oxide coating is formed over the metal coating.

23. The component according to claim 22 wherein the metal coating is formed on at least a portion of a surface of the component main unit.

24. The component according to claim 22 wherein the first oxide coating is formed on at least a portion of a surface of the metal coating.

25. The component according to claim 22 wherein the metal coating is formed on at least a portion of a surface of the component main unit, and wherein the first oxide coating is formed on at least a portion of a surface of the metal coating.

26. The component according to claim 25 wherein the first oxide coating comprises an anodic oxide coating.

27. The component according to claim 25 wherein the metal coating comprises an aluminum coating.

28. The component according to claim 27 wherein the first oxide coating comprises an anodic oxide coating.

29. The component according to claim 1 wherein the component main unit comprises magnesium.

30. The component according to claim 29 wherein the component main unit comprises a magnesium alloy.

31. The component according to claim 29 wherein the metal coating comprises an aluminum coating.

32. The component according to claim 29 wherein the first oxide coating comprises an anodic oxide coating.

33. The component according to claim 32 wherein the metal coating comprises an aluminum coating.

34. The component according to claim 29 wherein the metal coating is formed over the first oxide coating.

35. The component according to claim 34 wherein the first oxide coating is formed on at least a portion of a surface of the component main unit.

36. The component according to claim 34 wherein the metal coating is formed on at least a portion of a surface of the first oxide coating.

37. The component according to claim 34 wherein the first oxide coating is formed on at least a portion of a surface of the component main unit, and wherein the metal coating is formed on at least a portion of a surface of the first oxide coating.

38. The component according to claim 37 wherein the component main unit comprises a magnesium alloy.

39. The component according to claim 37 wherein the first oxide coating comprises an anodic oxide coating.

40. The component according to claim 37 wherein the metal coating comprises an aluminum coating.

41. The component according to claim 40 wherein the first oxide coating comprises an anodic oxide coating.

42. The component according to claim 34 further comprising a second oxide coating formed over at least a part of the component main unit.

43. The component according to claim 42 wherein the second oxide coating is formed over the metal coating.

44. The component according to claim 43 wherein the first oxide coating is formed on at least a portion of a surface of the component main unit, wherein the metal coating is formed on at least a portion of a surface of the first oxide coating, and wherein the second oxide coating is formed on at least a portion of a surface of the metal coating.

45. The component according to claim 44 wherein the component main unit comprises a magnesium alloy.

46. The component according to claim 44 wherein the first oxide coating comprises a first anodic oxide coating.

47. The component according to claim 44 wherein the second oxide coating comprises a second anodic oxide coating.

48. The component according to claim 44 wherein the metal coating comprises an aluminum coating.

49. The component according to claim 48 wherein the first oxide coating comprises a first anodic oxide coating.

50. The component according to claim 49 wherein the second oxide coating comprises a second anodic oxide coating.

51. The component according to claim 1 wherein the first oxide coating comprises an anodic oxide coating.

52. The component according to claim 1 wherein the metal coating is formed using a physical deposition method.

53. The component according to claim 52 wherein the physical deposition method comprises sputtering.

54. The component according to claim 52 wherein the physical deposition method comprises vacuum deposition.

55. The component according to claim 52 wherein the physical deposition method comprises ion plating.

56. The component according to claim 1 wherein the component main unit comprises a bicycle component used in an outdoor environment.

57. The component according to claim 1 wherein the component main unit comprises a fishing reel component used in an outdoor environment.

58. A plated component used in an outdoor environment comprising:
a component main unit comprising aluminum;
an aluminum coating formed by physical deposition on at least a portion of a surface of the component main unit that is exposed to the outdoor environment; and
an anodic oxide coating formed on at least a portion of a surface of the aluminum coating.

59. A plated component used in an outdoor environment comprising:
a component main unit comprising magnesium;
a first anodic oxide coating formed on at least a portion of a surface of the component main unit that is exposed to the outdoor environment; and
an aluminum coating formed by physical deposition on at least a portion of a surface of the first anodic oxide coating.

60. The component according to claim 59 further comprising a second anodic oxide coating formed on at least a portion of a surface of the aluminum coating.

61. A plated component used in an outdoor environment comprising:
a component main unit comprising synthetic resin;
an aluminum coating formed by physical deposition on at least a portion of a surface of the component main unit that is exposed to the outdoor environment; and
an anodic oxide coating formed on at least a portion of a surface of the aluminum coating.
